(19) United States
(12) Patent Application Publication
(10) Pub. No.: US 2025/0312133 A1
(43) Pub. Date: Oct. 9, 2025

(54) ELECTRIC TOOTHBRUSH

(71) Applicant: YINGJIE HAOTIAN (GUANGDONG) ELECTRONIC TECHNOLOGY CO., LTD, DONGGUAN (CN)

(72) Inventor: RONGGUI WEN, DONGGUAN (CN)

(21) Appl. No.: 18/625,206

(22) Filed: Apr. 3, 2024

(51) Int. Cl. A61C 17/34; A61C 17/22

(52) U.S. Cl. CPC A61C 17/3472; A61C 17/222; A61C 17/224; A61C 17/225; A61C 17/3481

(57) ABSTRACT

An electric toothbrush, including a handle, a motor, and a brush head. The handle defines an accommodating cavity, the motor is driven by electric power, and the motor includes a motor housing and a power shaft, the motor housing is accommodated in the accommodating cavity, the power shaft is movably connected to the motor housing and moves in multi-directions along an axial direction of the motor housing, the power shaft passes through the handle, the brush head is connected to the power shaft and is driven by the power shaft to swing, rotate, and/or vibrate with respect to the handle.

### TECHNICAL FIELD

The present disclosure relates to a technical field of electric toothbrushes, and in particular to an electric toothbrush.

### BACKGROUND

With the development of science and technology, electric toothbrushes are applied daily life of people, currently, the electric toothbrushes are rapidly rotated or vibrated through motor cores, so that corresponding brush heads are driven to generate high-frequency vibration, thereby instantly decomposing toothpaste into fine foam to deeply cleaning tooth gaps of the people.

In the prior art, a current electric toothbrush includes a handle and a brush head, the tooth brush is swingably connected to the handle, at this time, a swing angle of the brush head with respect to the handle is ranged from 10° to 20°, which limits ability of the brush head to cover tooth surface of users, thereby limiting a coverage range of the current electric toothbrush in a cleaning process, as such, an effect of cleaning teeth of the users using the current electric toothbrush is poor.

### SUMMARY

The present disclosure aims to provide an electric toothbrush, in which a handle defines an accommodating cavity, a motor is driven by electric power, the motor includes a motor housing and a power shaft, the motor housing is accommodated in the accommodating cavity, a power shaft is movably connected to the motor housing and moves in multi-directions along an axial direction of the motor housing, the power shaft passes through the handle, a brush head is connected to the power shaft and is driven by the power shaft to swing, rotate, and/or vibrate with respect to the handle. At this time, the power shaft drives the brush head to move in the multi-directions with respect to the motor housing, so as to expand a swing range of the brush head with respect to the motor housing, thereby expanding a coverage range of the brush head in a cleaning process, in this way, ability of covering tooth surface of users of the brush head is avoided from being limited, and an effect of cleaning teeth of the users using the electric toothbrush is improved.

In order to achieve above aims, the present disclosure provides following technical solutions.

The present disclosure provides the electric toothbrush, including the handle, the motor, and the brush head. The handle defines the accommodating cavity, the motor is driven by electric power, and the motor includes the motor housing and the power shaft, the motor housing is accommodated in the accommodating cavity, the power shaft is movably connected to the motor housing and moves in the multi-directions along the axial direction of the motor housing, the power shaft passes through the handle, the brush head is connected to the power shaft and is driven by the power shaft to swing, rotate, and/or vibrate with respect to the handle.

Furthermore, the power shaft includes a first magnetic portion, the first magnetic portion is disposed in the motor housing. A second magnetic portion is disposed in the motor housing, the second magnetic portion is disposed around a peripheral side of the first magnetic portion, the second magnetic portion is magnetically connected to the first magnetic portion, the first magnetic portion moves with respect to the motor housing under an action of the second magnetic portion, and the power shaft swings, rotates, and/or vibrates with respect to the handle along with movement of the first magnetic portion.

Furthermore, the second magnetic portion is configured to connect to a power supply, and the second magnetic portion adjusts a magnetic flux thereof when being energized. The movement of the first magnetic portion is regulated based on changes of the magnetic flux of the second magnetic portion.

Furthermore, the handle defines a first through hole on a top thereof, and the first through hole is communicated with the accommodating cavity. The power shaft passes through the accommodating cavity and the first through hole, a movement space is defined between a peripheral side wall of the power shaft and an inner side wall of the first through hole.

Furthermore, the electric toothbrush further includes a flexible sleeve, the flexible sleeve is disposed in the first through hole. The flexible sleeve is sleeved on the power shaft and is hermetically connected to the first through hole. The flexible sleeve is flexibly deformed along with movement of the power shaft.

Furthermore, a step groove is defined in an inner side wall portion, close to the first through hole, of the accommodating cavity. The flexible sleeve includes a flexible sleeve main body and a step portion, the flexible sleeve main body is sleeved on the power shaft and hermetically attaches to the peripheral side wall of the power shaft and the inner side wall of the first through hole. the step portion is connected to the flexible sleeve main body and is located and connected to the step groove.

Furthermore, a boss portion protrudes downward from the flexible sleeve main body, the boss portion is a hollow cylinder, and the power shaft passes through the boss portion.

Furthermore, the electric toothbrush further includes a brush rod support. The brush rod support is disposed between the power shaft and the brush head. A portion of the power shaft exposing from the handle is connected to the brush rod support, and passes through the brush rod support to connect to the brush head. The brush rod support includes a clamping arm, the clamping arm is elastically clamped to the power shaft.

Furthermore, the brush head includes a brush main body and a bristle assembly, the bristle assembly is installed on the brush main body, and the brush main body is detachably installed to brush rod support.

Furthermore, a mounting groove is defined on a top of the brush main body; the bristle assembly includes a bristle plate and bristles. The bristle plate is installed in the mounting groove, the bristles are installed on the bristle plate and are configured to brush teeth.

Furthermore, the bristle assembly further includes a counterweight block, the counterweight block is disposed in the mounting groove, and the counterweight block is clamped between the bristle plate and the brush main body.

Furthermore, the electric toothbrush further includes at least one motor support, the at least one motor support is disposed between the motor and the handle. The at least one motor support is installed on an inner side wall of the accommodating cavity and supports the motor.

Furthermore, a plurality of motor supports are provided, the plurality of the motor supports are arranged along an axis of the motor, and the plurality of the motor supports respectively support different parts of the motor.

Furthermore, the electric toothbrush further includes a circuit board. The circuit board is disposed at outer sides of the plurality of the motor supports and is installed on peripheral side walls of the plurality of the motor supports.

Furthermore, a charging assembly is disposed at a bottom of the handle, the charging assembly includes charging components, and the charging components are configured to electrically connected to a charging base.

Furthermore, charging holes are defined on the bottom of the handle, the charging components are exposed to the charging holes, and the charging components are pogo pins.

Furthermore, the charging assembly further includes a first magnet, the first magnet is disposed in the handle and is close to the bottom of the handle, and the first magnet is configured to magnetically connected to the charging base.

Furthermore, at least one breathing lamp is disposed in the handle. A light-transmitting portion is disposed on the bottom of the handle, and the light-transmitting is configured to expose lights transmitted by the at least one breathing lamp.

Furthermore, the light-transmitting portion is annularly disposed on the bottom of the handle, and the at least one breathing lamp flashes according to power states of the charging assembly.

Compared with the prior art, the present disclosure has following beneficial effects.

The present disclosure provides the electric toothbrush, in which the handle defines the accommodating cavity, the motor is driven by the electric power, the motor includes the motor housing and the power shaft, the motor housing is accommodated in the accommodating cavity, the power shaft is movably connected to the motor housing and moves in the multi-directions along the axial direction of the motor housing, the power shaft passes through the handle, the brush head is connected to the power shaft and is driven by the power shaft to swing, rotate, and/or vibrate with respect to the handle. At this time, the power shaft drives the brush head to move in the multi-directions with respect to the motor housing, so as to expand the swing range of the brush head with respect to the motor housing, thereby expanding the coverage range of the brush head in the cleaning process, in this way, the ability of covering the tooth surface of the users of the brush head is avoided from being limited, and the effect of cleaning the teeth of the users using the electric toothbrush is improved.

### BRIEF DESCRIPTION OF DRAWINGS

In order to more clearly illustrate embodiments of the present disclosure or technical solutions in the prior art, drawings that need to be used in the embodiments or the prior art are briefly described below, and it is obvious that the drawings in following description are merely some embodiments of the present disclosure, and for those who skilled in the art, other drawings may be obtained according to structures shown in the accompanying drawings without creative efforts.

For a more complete understanding of the present disclosure and beneficial effects thereof, following descriptions are made in conjunction with the accompanying drawings, in which the same reference numeral refer to the same part in the following descriptions.

FIG. 1 is a schematic diagram of an electric toothbrush according to one embodiment of the present disclosure.

FIG. 2 is an exploded schematic diagram of the electric toothbrush according to one embodiment of the present disclosure.

FIG. 3 is a schematic diagram of a handle of the electric toothbrush according to one embodiment of the present disclosure.

FIG. 4 is a cross-sectional schematic diagram of the handle of the electric toothbrush according to one embodiment of the present disclosure.

FIG. 5 is a schematic diagram of a motor of the electric toothbrush according to one embodiment of the present disclosure.

FIG. 6 is a cross-sectional schematic diagram of the motor of the electric toothbrush according to one embodiment of the present disclosure.

FIG. 7 is a schematic diagram of a brush head of the electric toothbrush according to one embodiment of the present disclosure.

FIG. 8 is an exploded schematic diagram of the brush head of the electric toothbrush according to one embodiment of the present disclosure.

FIG. 9 is a schematic diagram of a flexible sleeve of the electric toothbrush represented in a first perspective view according to one embodiment of the present disclosure.

FIG. 10 is a schematic diagram of the flexible sleeve of the electric toothbrush represented in a second perspective view according to one embodiment of the present disclosure.

FIG. 11 is a cross-sectional schematic diagram of the flexible sleeve of the electric toothbrush according to one embodiment of the present disclosure.

FIG. 12 is a schematic diagram of a brush rod support of the electric toothbrush according to one embodiment of the present disclosure.

Reference numerals in the drawings: 100. electric toothbrush; 10. handle; 10a. accommodating cavity; 10b. first through hole; 10c. step groove; 11d. charging hole; 11. charging assembly; 111. charging component; 112. first magnet; 12. breathing lamp; 13. light-transmitting portion; 20. motor; 21. motor housing; 211. second magnetic portion; 22. power shaft; 221. first magnetic portion; 30. brush head; 31. brush main body; 31a. mounting groove; 32. bristle assembly; 321. bristle plate; 322. bristle; 323. counterweight block; 40. flexible sleeve; 41. flexible sleeve main body; 411. boss portion; 42. step portion; 50. brush rod support; 51. clamping arm; 60. motor support; and 70. circuit board.

### DETAILED DESCRIPTION OF EMBODIMENTS

Following clearly and completely describes technical solutions in embodiments of the present disclosure with reference to accompanying drawings in the embodiments of the present disclosure. Apparently, the described embodiments are only some but not all of the embodiments of the present disclosure. All other embodiments obtained by those who skilled in the art based on the embodiments of the present disclosure without creative efforts shall fall within a protection scope of the present disclosure.

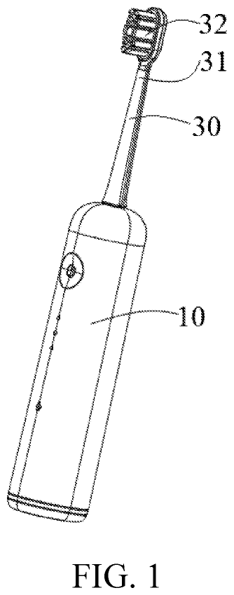

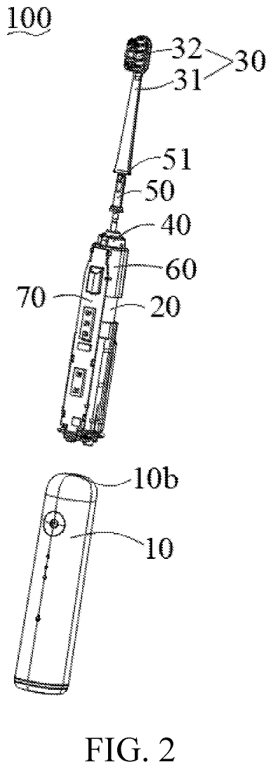

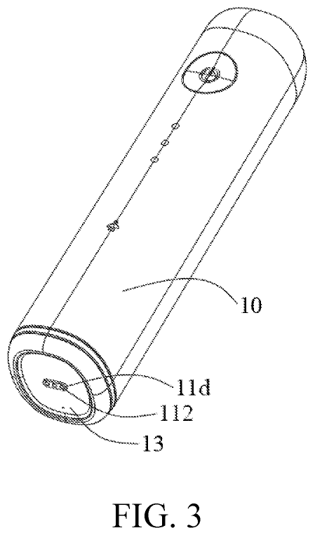

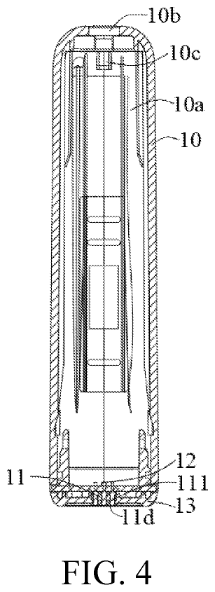

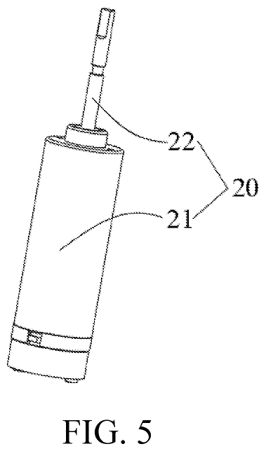

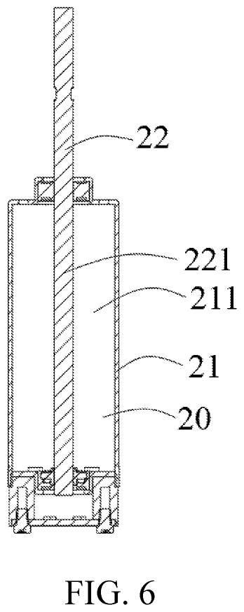

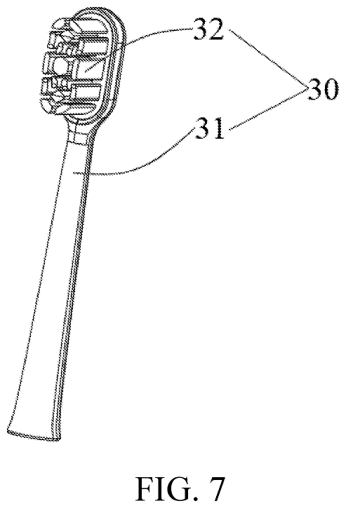

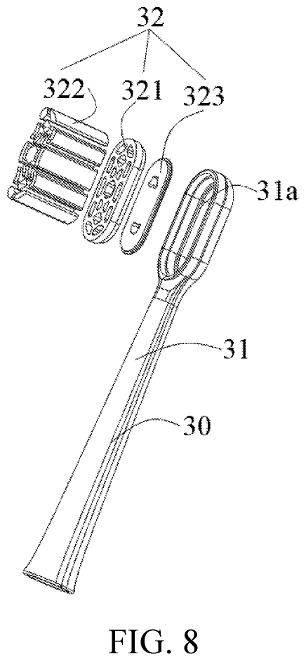

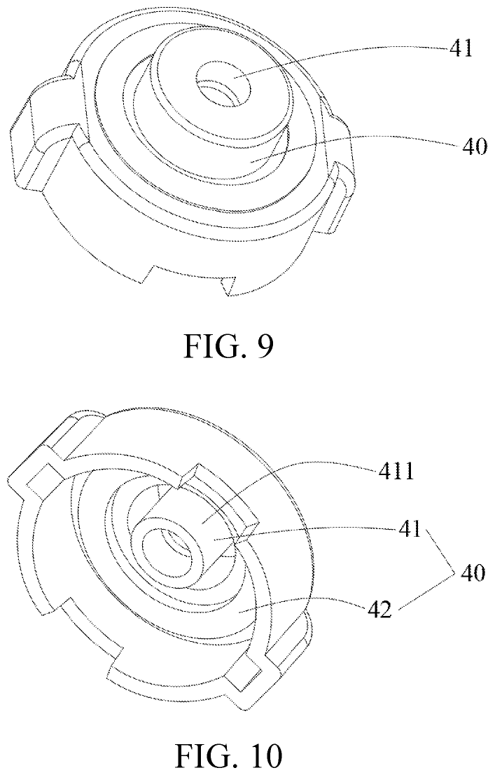

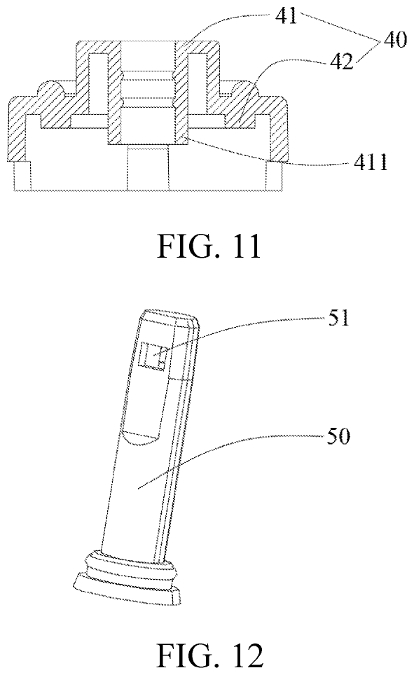

Please refer to FIGS. 1-12, the embodiments of the present disclosure provide an electric toothbrush 100, the electric toothbrush 100 is provided to clean teeth of users, the electric toothbrush 100 includes a handle 10, a motor 20, and a brush head 30, the motor 20 is disposed between the handle 10 and the brush head 30.

In the embodiments of the present disclosure, the handle 10 serves as a supporting component of the electric toothbrush 100 and supports the motor 20 and the brush head 30, the handle 10 defines an accommodating cavity 10a, and the accommodating cavity serves as an inner space of the handle 10 and is configured to accommodate the motor 20.

In the embodiments of the present disclosure, the motor 20 is driven by electric power, and the motor 20 includes a motor housing 21 and a power shaft 22, the motor housing 21 is accommodated in the accommodating cavity 10a, the power shaft 22 is movably connected to the motor housing 21 and moves in multi-directions along an axial direction of the motor housing 21, the power shaft 22 passes through the handle 10. At this time, the motor 20 is composed of the motor housing 21 and the power shaft 22, the motor housing 21 is disposed in the handle 10, the motor housing 21 is accommodated in the accommodating cavity 10a, so that the motor housing 21 is connected to the handle 10 through the accommodating cavity 10a, the power shaft 22 is disposed on the upper side of the motor housing 21, and the power shaft 22 is movably connected to the motor housing 21 and moves in the multi-directions along the axial direction of the motor housing 21, so as to adjust a position of the power shaft 22 with respect to the motor housing 21.

In the embodiments of the present disclosure, the brush head 30 is disposed on an upper side of the power shaft 22, the brush head 30 is connected to the power shaft 22 and is driven by the power shaft 22 to swing, rotate, and/or vibrate with respect to the handle 10. The power shaft 22 drives the brush head 30 to move in the multi-directions with respect to the motor housing 21, so as to expand a swing range of the brush head 30 with respect to the motor housing 21, thereby expanding a coverage range of the brush head 30 in a cleaning process, in this way, ability of covering tooth surface of users of the brush head 30 is avoided from being limited, and an effect of cleaning teeth of the users using the electric toothbrush 100 is improved. In one embodiment, a swing amplitude of the brush head 30 is ranged from 0° to 60°.

The power shaft 22 includes a first magnetic portion 221 at a lower portion thereof, the first magnetic portion 221 is disposed in the motor housing 21. A second magnetic portion 211 is disposed in the motor housing 21, the second magnetic portion 211 is disposed around a peripheral side of the first magnetic portion 221, the second magnetic portion 211 is magnetically connected to the first magnetic portion 221, for the second magnetic portion 211 and the first magnetic portion 221, like charges repel, so that the first magnetic portion 221 moves with respect to the motor housing 21 under an action of the second magnetic portion 211, and the power shaft 22 swings, rotates, and/or vibrates with respect to the handle 10 along with the movement of the first magnetic portion 221, so as to expand the swing range of the brush head 30 with respect to the motor housing 21, thereby expanding the coverage range of the brush head 30 in the cleaning process, in this way, the ability of covering the tooth surface of the users of the brush head 30 is avoided from being limited, and the effect of cleaning the teeth of the users using the electric toothbrush 100 is improved.

The second magnetic portion 211 is configured to connect to a power supply, the second magnetic portion 211 adjusts a magnetic flux thereof when being energized, and the movement of the first magnetic portion 221 is regulated based on changes of the magnetic flux of the second magnetic portion 211, which is convenient for the second magnetic portion 211 being energized to regulate the first magnetic portion 221, so as to conveniently adjust the position of the power shaft 22 with respect the motor housing 21, and when the second magnetic portion 211 is not energized, the first magnetic portion 221 is fixed and does not move.

The handle 10 defines a first through hole 10b on a top thereof, and the first through hole 10b is communicated with the accommodating cavity 10a. The power shaft 22 passes through the accommodating cavity 10a and the first through hole 10b, so that the power shaft 22 enters the accommodating cavity 10a from top to bottom through the first through hole 10b, there is a gap between a peripheral side wall of the power shaft 22 and an inner side wall of the first through hole 10b, and a movement space is defined between the peripheral side wall of the power shaft 22 and the inner side wall of the first through hole 10b, which is convenient for the power shaft 22 to swing, rotate, and/or vibrate with respect to the first through hole 10b.

In the embodiments of the present disclosure, the electric toothbrush 100 further includes a flexible sleeve 40 between the handle 10 and the power shaft 22, the flexible sleeve 40 is disposed in the first through hole 10b. The flexible sleeve 40 is sleeved on the power shaft 22, which is convenient for the flexible sleeve 40 to fix to the power shaft 22, the flexible sleeve 40 is hermetically connected to the first through hole, so that the flexible sleeve 40 and the power shaft 22 block the first through hole 10b to prevent water and dust from entering the accommodating cavity 10a through the first through hole 10b. The flexible sleeve 40 is flexibly deformed along with movement of the power shaft 22, so that the power shaft 22 is capable of moving with respect to the first through hole 10b. In one embodiment, the flexible sleeve 20 is a flexible silicone member.

A step groove 10c is defined in an inner side wall portion, close to the first through hole 10b, of the accommodating cavity 10a. The flexible sleeve 40 includes a flexible sleeve main body 41 and a step portion 42, the flexible sleeve main body 41 is sleeved on the power shaft 22 and hermetically attaches to the peripheral side wall of the power shaft 22 and the inner side wall of the first through hole 10b, so that the flexible sleeve main body 41 blocks the first through hole 10b to prevent the water and the dust from entering the accommodating cavity 10a through the first through hole 10b. The step portion 42 is connected to the flexible sleeve main body 41 and is located and connected to the step groove 10c, so that the flexible sleeve 40 is located and connected to the handle 10 through the step portion 42 and the step groove 10c, thereby ensuing location accuracy between the flexible sleeve 40 and the handle 10.

A boss portion 411 protrudes downward from the flexible sleeve main body 41, the boss portion 411 is a hollow cylinder, and the power shaft 22 passes through the boss portion 411, so that a contact area between the flexible sleeve main body 41 and the power shaft 22 is increased through the boss portion 411, thereby improving connection stability between the flexible sleeve main body 41 and the power shaft 22.

In some embodiments of the present disclosure, the electric toothbrush 100 further includes a brush rod support 50. The brush rod support 50 is disposed between the power shaft 22 and the brush head 30. A portion of the power shaft 22 exposing from the handle 10 is connected to the brush rod support 50, and passes through the brush rod support 50 to connect to the brush head 30, so that the brush head 30 is connected to the power shaft 22 through the brush rod support 50. The brush rod support 50 includes a clamping arm 51, the clamping arm 51 is elastically clamped to the power shaft 22, so that the brush rod support 50 is clamped with the power shaft 22 through the clamping arm 51.

The brush head 30 includes a brush main body 31 and a bristle assembly 32, the bristle assembly 32 is installed on the brush main body 31, so that the bristle assembly 32 is fixed to the brush main body 31, and the brush main body 31 is detachably installed to brush rod support 50, so that the brush main body 31 is capable of connecting to or detaching from the brush rod support 50. When the brush main body 31 is connected to the brush rod support 50, the brush head 30 is capable of cleaning the teeth of the users; and when the brush main body 32 is detached from the brush rod support 50, the brush head 30 is capable of being replaced, so as to ensure use performance of the brush head 30.

At this time, a mounting groove 31a is defined on atop of the brush main body 31, the mounting groove 31a is recessed inward from the brush main body 31, the bristle assembly 32 includes a bristle plate 321 and bristles 322, an outer contour of the bristle plate 321 is in interference fit with an inner contour of the mounting groove 31a, the bristle plate 321 is installed in the mounting groove 31a, so that the bristle plate 321 is connected to the brush main body 31 through the mounting groove 31a, the bristles 322 are installed on the bristle plate 321 and are configured to brush teeth, so that the bristles 322 are fixed to the bristle plate 321 to brush the teeth of the users.

In some embodiments of the present disclosure, the bristle assembly 32 further includes a counterweight block 323, the counterweight block 323 is disposed in the mounting groove 31a, and the counterweight block 323 is clamped between the bristle plate 321 and the brush main body 31, so that the counterweight block 323 is fixed between brush main body 31 and the bristle plate 321. The counterweight block 323 is configured to increase its own weight to keep balance between the bristle plate 321 and the brush main body 31, so that noise of the bristle assembly 32 is reduced. In one embodiment, the counterweight block 323 is a metal block or a non-metal block.

In some embodiments of the present disclosure, the electric toothbrush 100 further includes at least one motor support 60, the at least one motor support 60 is disposed between the motor 20 and the handle 10. The at least one motor support 60 is installed on an inner side wall of the accommodating cavity 10a and supports the motor 20, so that the motor 20 is connected to the handle 10 through the at least one motor support 60, thereby facilitating the motor 20 to be fixed to the handle 10.

In one embodiment, a plurality of motor supports 60 are provided, the plurality of the motor supports 60 are arranged along an axis of the motor 20, and the plurality of the motor supports 60 respectively support different parts of the motor 20, so that the plurality of the motor supports 60 are respectively fixed to an upper side and a lower side of the motor 20, thereby improving connection stability between the plurality of the motor supports 60 and the motor 20.

In some embodiments of the present disclosure, the electric toothbrush 100 further includes a circuit board 70. The circuit board 70 is disposed in the handle 10 and is disposed at outer sides of the plurality of the motor supports 60 and are installed on peripheral side walls of the plurality of the motor supports 60, thereby facilitating the circuit board 70 to fix to the peripheral side walls of the plurality of the motor supports 60, the circuit board 70 serves as a circuit connection point of the motor 20.

A charging assembly 11 is disposed at a bottom of the handle 10, the charging assembly 11 includes charging components 111, the charging components 111 are connected to the motor 20, and the charging components 111 are configured to electrically connected to a charging base, so that the charging components 111 are charged through the charging base, thereby facilitating the charging components 111 to supply power to the motor 20.

Charging holes 10d are defined on the bottom of the handle 10, the charging components 111 are exposed to the charging holes 10d, and the charging components 111 are pogo pins, so that the charging components 111 are inserted into the charging base from top to bottom, thereby facilitating improving charging convenience of the charging components 111.

In some embodiments of the present disclosure, the charging assembly 11 further includes a first magnet 112, the first magnet 112 is disposed in the handle 10 and is close to the bottom of the handle 10, and the first magnet 112 is configured to magnetically connected to the charging base, so that the charging assembly 11 is magnetically connected to the charging base through the first magnet 112 and the charging assembly 11 is fixed to the charging base along a vertical direction, thereby ensuing charging stability between the charging assembly 11 and the charging base.

At least one breathing lamp 12 is disposed in the handle 10. The at least one breathing lamp 12 is electrically connected to the charging components 111, a light-transmitting portion 13 is disposed on the bottom of the handle 10, and the light-transmitting 13 is configured to expose lights transmitted by the at least one breathing lamp 12, so that the users may see light condition of the at least breathing lamp 12 through the light-transmitting portion 13 in an external environment.

The light-transmitting portion 13 is annularly disposed on the bottom of the handle 10, and the at least one breathing lamp 12 flashes according to power states of the charging assembly, so that the users may see a battery voltage of the charging assembly 11 through observing the at least one breathing lamp 12, the at least one breathing lamp 12 plays a role in reminding.

Compared with the prior art, the present disclosure has following beneficial effects.

The present disclosure provides the electric toothbrush 100, in which the handle 10 defines the accommodating cavity 10a, the motor 20 is driven by the electric power, the motor 20 includes the motor housing 21 and the power shaft 22, the motor housing 21 is accommodated in the accommodating cavity 10a, the power shaft 22 is movably connected to the motor housing 21 and moves in the multi-directions along the axial direction of the motor housing 21, the power shaft 22 passes through the handle 10, the brush head 30 is connected to the power shaft 22 and is driven by the power shaft 22 to swing, rotate, and/or vibrate with respect to the handle 10. At this time, the power shaft 22 drives the brush head 30 to move in the multi-directions with respect to the motor housing 21, so as to expand the swing range of the brush head 30 with respect to the motor housing 21, thereby expanding the coverage range of the brush head 30 in the cleaning process, in this way, the ability of covering the tooth surface of the users of the brush head 30 is avoided from being limited, and the effect of cleaning the teeth of the users using the electric toothbrush 100 is improved.

In the foregoing embodiments, description of each embodiment has its own emphasis, and for a part that is not described in detail in an embodiment, reference may be made to related descriptions of other embodiments.

In the description of the present disclosure, terms “first” and “second” are only used for descriptive purposes, and cannot be understood as indicating or implying relative importance or implicitly indicating the number of indicated technical features. Thus, features defined with “first” and “second” may explicitly or implicitly include one or more features.

Principles and embodiments of the present disclosure are described herein by using specific examples, and the description of the above embodiments is only used to help understand methods and a core idea of the present disclosure; meanwhile, for those who skilled in the art, according to the core idea of the present disclosure, there may be changes in specific implementations and application ranges, and in conclusion, a content of the specification should not be understood as a limitation to the present disclosure.

What is claimed is:

1. An electric toothbrush, comprising:
a handle;
a motor; and
a brush head;
wherein the handle defines an accommodating cavity; the motor is driven by electric power, and the motor comprises a motor housing and a power shaft, the motor housing is accommodated in the accommodating cavity; the power shaft is movably connected to the motor housing and moves in multi-directions along an axial direction of the motor housing; the power shaft passes through the handle; the brush head is connected to the power shaft and is driven by the power shaft to swing, rotate, and/or vibrate with respect to the handle.

2. The electric toothbrush according to claim 1, wherein the power shaft comprises a first magnetic portion, the first magnetic portion is disposed in the motor housing;
a second magnetic portion is disposed in the motor housing, the second magnetic portion is disposed around a peripheral side of the first magnetic portion, the second magnetic portion is magnetically connected to the first magnetic portion, the first magnetic portion moves with respect to the motor housing under an action of the second magnetic portion, and the power shaft swings, rotates, and/or vibrates with respect to the handle along with movement of the first magnetic portion.

3. The electric toothbrush according to claim 2, wherein the second magnetic portion is configured to connect to a power supply, and the second magnetic portion adjusts a magnetic flux thereof when being energized; the movement of the first magnetic portion is regulated based on changes of the magnetic flux of the second magnetic portion.

4. The electric toothbrush according to claim 2, wherein the handle defines a first through hole on a top thereof, and the first through hole is communicated with the accommodating cavity; and
the power shaft passes through the accommodating cavity and the first through hole, a movement space is defined between a peripheral side wall of the power shaft and an inner side wall of the first through hole.

5. The electric toothbrush according to claim 4, wherein the electric toothbrush further comprises a flexible sleeve, the flexible sleeve is disposed in the first through hole; and
the flexible sleeve is sleeved on the power shaft and is hermetically connected to the first through hole; and the flexible sleeve is flexibly deformed along with movement of the power shaft.

6. The electric toothbrush according to claim 5, wherein a step groove is defined in an inner side wall portion, close to the first through hole, of the accommodating cavity;
the flexible sleeve comprises a flexible sleeve main body and a step portion, the flexible sleeve main body is sleeved on the power shaft and hermetically attaches to the peripheral side wall of the power shaft and the inner side wall of the first through hole; and
the step portion is connected to the flexible sleeve main body and is located and connected to the step groove.

7. The electric toothbrush according to claim 6, wherein a boss portion protrudes downward from the flexible sleeve main body, the boss portion is a hollow cylinder, and the power shaft passes through the boss portion.

8. The electric toothbrush according to claim 2, wherein the electric toothbrush further comprises a brush rod support; the brush rod support is disposed between the power shaft and the brush head;
a portion of the power shaft exposing from the handle is connected to the brush rod support, and passes through the brush rod support to connect to the brush head; and
the brush rod support comprises a clamping arm, the clamping arm is elastically clamped to the power shaft.

9. The electric toothbrush according to claim 8, wherein the brush head comprises a brush main body and a bristle assembly, the bristle assembly is installed on the brush main body, and the brush main body is detachably installed to brush rod support.

10. The electric toothbrush according to claim 9, wherein a mounting groove is defined on a top of the brush main body; the bristle assembly comprises a bristle plate and bristles; the bristle plate is installed in the mounting groove; the bristles are installed on the bristle plate and are configured to brush teeth.

11. The electric toothbrush according to claim 10, wherein the bristle assembly further comprises a counterweight block, the counterweight block is disposed in the mounting groove, and the counterweight block is clamped between the bristle plate and the brush main body.

12. The electric toothbrush according to claim 1, wherein the electric toothbrush further comprises at least one motor support, the at least one motor support is disposed between the motor and the handle; and
the at least one motor support is installed on an inner side wall of the accommodating cavity and supports the motor.

13. The electric toothbrush according to claim 12, wherein a plurality of motor supports are provided, the plurality of the motor supports are arranged along an axis of the motor; and the plurality of the motor supports respectively support different parts of the motor.

14. The electric toothbrush according to claim 13, wherein the electric toothbrush further comprises a circuit board; and
the circuit board is disposed at outer sides of the plurality of the motor supports and is installed on peripheral side walls of the plurality of the motor supports.

15. The electric toothbrush according to claim 1, wherein a charging assembly is disposed at a bottom of the handle, the charging assembly comprises charging components, and the charging components are configured to electrically connected to a charging base.

16. The electric toothbrush according to claim 15, wherein charging holes are defined on the bottom of the handle, the charging components are exposed to the charging holes, and the charging components are pogo pins.

17. The electric toothbrush according to claim 15, wherein the charging assembly further comprises a first magnet, the first magnet is disposed in the handle and is close to the bottom of the handle; the first magnet is configured to magnetically connected to the charging base.

18. The electric toothbrush according to claim 15, wherein at least one breathing lamp is disposed in the handle; a light-transmitting portion is disposed on the bottom of the handle, and the light-transmitting is configured to expose lights transmitted by the at least one breathing lamp.

19. The electric toothbrush according to claim 18, wherein the light-transmitting portion is annularly disposed on the bottom of the handle, and the at least one breathing lamp flashes according to power states of the charging assembly.
